(19) United States
(12) Patent Application Publication
(10) Pub. No.: US 2017/0044047 A1
(43) Pub. Date: Feb. 16, 2017

(54) METHOD AND DEVICE FOR GENERATING A DIAMETER-ENLARGED END ON AN OPTICAL FIBER

(71) Applicant: fiberware Generalunternehmen für Nachrichtentechnik GmbH, Mittweida (DE)

(72) Inventors: Georg Kuka, Berlin (DE); Naim Ashraf, Bonn (DE); Lajos Bognar, Zug (CH); Julia Sittner, Mittweida (DE)

(73) Assignee: fiberware Generalunternehmen für Nachrichtentechninik GmbH, Mittweida (DE)

(21) Appl. No.: 15/235,586

(22) Filed: Aug. 12, 2016

Related U.S. Application Data
(63) Continuation of application No. 62/205,182, filed on Aug. 14, 2015.

(51) Int. Cl. C03B 37/15; G02B 6/02; C03C 25/10; G02B 1/18; C03B 37/16; C03C 25/00

(52) U.S. Cl. CPC C03B 37/15; C03B 37/16; C03C 25/005; C03C 25/104; G02B 1/18; G02B 6/02004; C03B 2203/06

(57) ABSTRACT

A method for generating a diameter-enlarged end on an optical fiber, includes placing a longitudinal subsection of a longitudinal section of the fiber into a heating zone and heating the longitudinal subsection, wherein first and second sides of the longitudinal section on either side of the longitudinal subsection are situated outside the heating zone; compressing the heated longitudinal subsection in a longitudinal direction of the optical fiber; pushing the first side of the longitudinal section toward the heating zone in the longitudinal direction and pulling the second side of the longitudinal section away from the heating zone in the longitudinal direction, wherein the first side of the longitudinal section is pushed to a greater degree than the second side of the longitudinal section is pulled, and generating an optical entry surface of the fiber by cutting the enlarged longitudinal subsection transversely to the longitudinal direction of the fiber.

### CROSS-REFERENCES TO RELATED APPLICATIONS

This application claims the benefit of prior filed U.S. provisional Application No. 62/205,182, filed Aug. 14, 2015, pursuant to 35 U.S.C. 119(e), the disclosure of which is incorporated herein by reference.

### BACKGROUND OF THE INVENTION

The invention relates to a method and device for providing an optical fiber with an end having an enlarged diameter. The end having the enlarged diameter is suitable for coupling in light of high-power lasers.

The following discussion of related art is provided to assist the reader in understanding the advantages of the invention, and is not to be construed as an admission that this related art is prior art to this invention.

It is well known that optical fibers require an increased diameter at their end to obtain a larger entry zone for coupling in light. This is especially important when laser light of a very high power is to be coupled in. A simple method of increasing the diameter is to add a piece of fiber having a larger diameter to the end of the fiber, e.g. by welding the piece of fiber on the end of the fiber (splicing).

The disadvantage when welding a piece of fiber onto the end of the fiber is that increased light absorption occurs at the weld, which leads to considerable heating of the welded joint at high laser powers and can destroy the fiber end.

It would therefore be desirable and advantageous to provide an improved method for providing an optical fiber with an end having an enlarged diameter without creating interference at the transition from the larger diameter to the smaller diameter (and vice versa) caused by increased light absorption, especially with laser light of high optical intensity.

### SUMMARY OF THE INVENTION

According to one aspect of the invention a method for generating a diameter-enlarged end on an optical fiber, includes placing a longitudinal subsection of the fiber into a heating zone and heating the longitudinal subsection, wherein first and second sides of the longitudinal section on either side of the longitudinal subsection are situated outside the heating zone; compressing the heated longitudinal subsection in a longitudinal direction of the optical fiber; pushing the first side of the longitudinal section toward the heating zone in the longitudinal direction and pulling the second side of the longitudinal section away from the heating zone in the longitudinal direction, wherein the first side of the longitudinal section is pushed to a greater degree than the second side of the longitudinal section is pulled, and generating an optical entry surface of the fiber by cutting the enlarged longitudinal subsection transversely to the longitudinal direction of the fiber.

In each case, the first side of the longitudinal section is pushed toward the heating zone more strongly than the second side of the longitudinal section is pulled away from the heating zone. The heated longitudinal subsection is therefore compressed in the longitudinal direction by an effective force (upsetting force) so that it bulges outwards in the radial direction corresponding to the force in the heated zone and so undergoes a radial thickening. The enlarged longitudinal subsection is cut transversely to longitudinal direction of the fiber in order to form an optical entry surface for coupling in of light. Depending on the type of separation the optical surface is ground and polished and further coated to preserve its optical properties.

The optical fiber has a refractive index profile transversely to the longitudinal direction of the fiber. The refractive index profile as a function of the radius divided by the respective diameter, i.e., the normalized refractive index profile, remains unchanged or the same in the longitudinal direction of the fiber from the enlarged fiber end to the longitudinal section (at least as far as into the longitudinal section of the optical fiber). The refractive index profile extends continuously in the longitudinal direction, i.e., without abrupt changes in the refractive index along the longitudinal direction.

A very simple example of a refractive index profile is a step index profile, where the refractive index is constant transversely to the longitudinal direction of the fiber.

Because there are no abrupt changes of the refractive index profile in the longitudinal direction, no interference due to increased light absorption is created at the transition from the larger diameter to the smaller diameter and vice versa.

According to another advantageous feature of the method according to the invention, the first and second sides of the longitudinal section of the fiber are moved at different speeds in the same direction so that the longitudinal subsection is pushed through the heating zone by the resulting difference in speed.

In order to keep the diameter along the optical fiber constant or to change the diameter, the speed difference during the movement is either kept constant or changed corresponding to the longitudinal displacement.

According to another aspect of the invention, a device for generating a diameter-enlarged end on an optical fiber includes an actuator operatively connected to two holders and configured to move the two holders independent of each other in a same direction at different speeds, wherein the holders are spaced apart from each other for holding a first and a second side of a longitudinal section of the optical fiber in a respective one of the holders; a heating zone positioned between the two holders so that a longitudinal subsection of the optical fiber situated between the first and second sides of the longitudinal section is located in the heating zone when the fiber is held by the two holders, wherein the heating device is configured to heat the longitudinal subsection above a softening point of a material of which the optical fiber is made, wherein the actuator is configured to displace one of the two holders so as to push the first side of the longitudinal section toward the heating zone in longitudinal direction of the optical fiber and to displace the other one of the two holders so as to pull the second side of the longitudinal section away from the heating zone in longitudinal direction to a greater degree by which the first side of the longitudinal section is pushed by the one of the two holders.

According to another advantageous feature of the device according to the invention, the heating zone is formed by plasma.

According to another advantageous feature of the device according to the invention, the plasma is formed by opposing electrodes that are electrically connected to each other via the plasma which is maintained and appropriately heated up by an electric current.

According to another advantageous feature of the device according to the invention, in order to obtain continuous increase in diameter the two holding devices move the first and second sides of the longitudinal section at different speeds in the same direction and so slide the longitudinal subsection with the resulting speed difference through the heating zone where the movement into the heating zone takes place faster than the movement out of the heating zone in each case.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a side view of a device for generating a diameter-enlarged end on an optical fiber,

FIG. 2 shows a top view of the device in FIG. 1 taken along section A-A;

FIGS. 3-5 each show a cross sectional view of an optical fiber during a phase in the method according to the invention; and

FIG. 6 shows a cross sectional view of the the fiber end of the optical fiber as in FIG. 5 with increased diameter and an optical surface extending transversely to the direction of the optical fiber.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

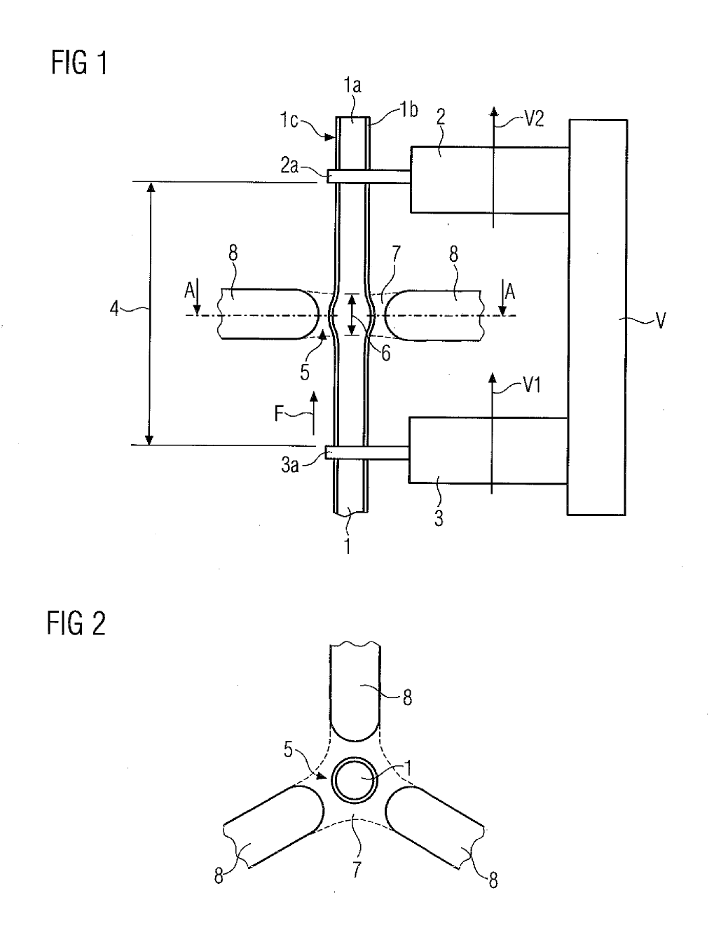

FIG. 1 shows a device used to generate a diameter-enlarged fiber end on an optical fiber 1 made of glass that has a core 1a and a cladding 1b. The core 1a can be doped and have a radial doping profile. The optical fiber 1 is held by two clamping arms 2a, 3a that belong to two holders 2, 3 of an actuator V. A fiber end 1c of the optical fiber 1 is shown in FIG. 1 above the holding device 2; the other end of the fiber is not shown

The longitudinal section 4 of the optical fiber 1 situated between the clamping arms 2a, 3a is subjected to a force F that acts from bottom to top in the longitudinal direction of the fiber. This force F in FIG. 1 is produced by the holder 3 against the holder 2 and is transmitted via the clamping arm 3a to the longitudinal section 4.

A longitudinal subsection 6 of the longitudinal section 4 is situated in a heating zone 5 in which the optical fiber 1 is heated above the softening point (transformation point) of the glass. The heating zone 5 is formed by a plasma 7 which is produced by an arc between three electrodes 8 and exhibits a correspondingly high temperature. The electrodes 8 are electrically connected with each other via the plasma 7; the flow of current through the plasma 7 correspondingly heats up the plasma and maintains the temperature of the plasma 7. As an alternative, the heating zone 5 can also be heated by a hydrogen-oxygen flame or by an appropriate laser (laser heating).

The force F applied to the longitudinal section 4 has the effect of compressing the heated, and softened, glass in the plasma 7 which causes the glass to move radially outwards and to initially form a bulge-shaped radial thickening. For this to occur, the softening point of the glass must be reached and under certain circumstances at least slightly exceeded so that the glass in the region of the longitudinal subsection 6 is sufficiently soft. The longitudinal section 4 of the optical fiber 1 with the bulge-shaped radial thickening is schematically shown in FIG. 1. In other words, the diameter of the heated optical fiber 1 has increased in the region of the longitudinal subsection 6 corresponding to force F, which compresses the optical fiber 1. The glass is deformed plastically, i.e. the deformation persists after cooling down, just as with radial doping and the diametrical ratio between core 1a and cladding 1b which are also retained.

The optical fiber 1 in the longitudinal section 4 is pushed on the one side in the direction of the heating zone 5 and, during the pushing, pulled out on the opposite side in each case. In FIG. 1 pushing is done from below and pulling from above; the pushing and pulling therefore take place in the same direction. The pushing is greater in each case than the pulling to produce the increase in glass material required for the thickening. The greater pushing corresponds to the force F.

The two clamping arms 2a, 3a of the holders 2, 3 are moved by the actuator V correspondingly along the longitudinal direction of the optical fiber 1 in the direction of the arrow 8, wherein the upper clamping arm 2a can move or slide independently of the lower clamping arm 2b.

The clamping arms 2a, 3a are displaced continuously with different velocities V1, V2, wherein the clamping arm 3a always moves faster than the clamping arm 2a (V1 greater than V2) so that the desired force F corresponding to the differential speed V1-V2 produces the bulging in the optical fiber 1 in the heating zone 5.

In order to achieve the desired shape of the transition (desired changes in diameter and thickness) from the optical fiber 1 to the end having the increased diameter the speeds of the clamping arms 2a, 3a and therefore the speed difference V1-V2 are appropriately selected.

The displacement of the clamping arms 2a, 3a can take place continuously—but also in steps.

In principle, the method can also be used to reduce the diameter; for this purpose the pushing must then however always be weaker than the pulling. An increased diameter can also be reduced again if the pushing is initially greater than the pulling and subsequently weaker than the pulling.

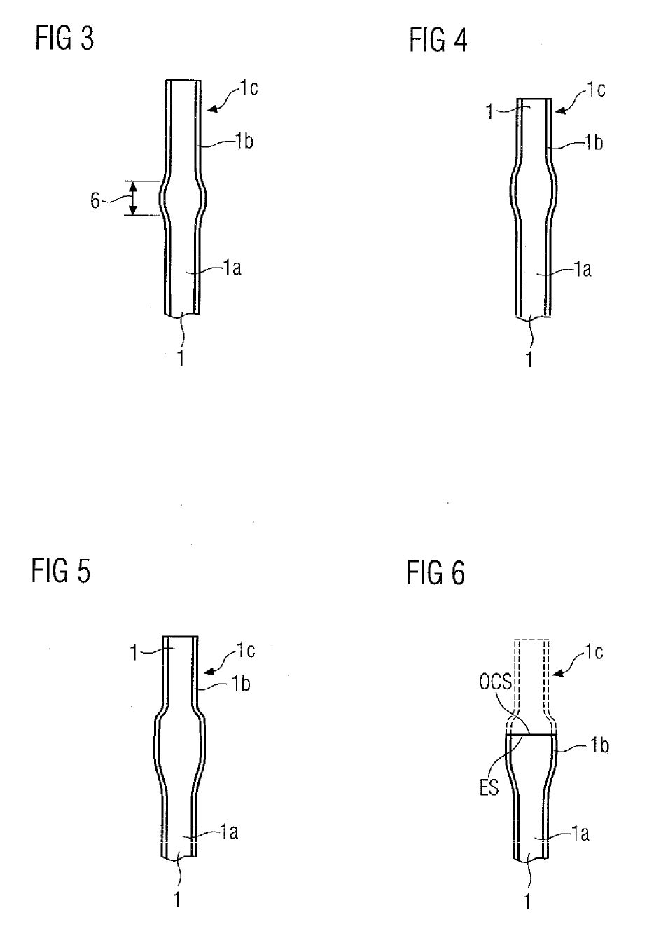

The resulting step-by-step increase in diameter is schematically shown in the example of FIGS. 3-5. In practice, the diameter can be easily doubled in this way.

The diameter is held constant once a particular diameter increase has been reached, as shown in FIG. 5.

The optical fiber 1 in the upper region (see FIG. 6), i.e., in the region where the fiber end 1c has been increased in diameter, is then cut transversely in order to form an optical entry surface. Depending on the type of separation, the resulting separation surface ES may still have to be finished and possibly provided with a coating (optical coating surface OCS) to preserve its optical properties.

The optical fiber has a refractive index profile transversely to the longitudinal direction of the fiber. The refractive index profile as a function of the radius divided by the respective diameter, i.e. the normalized refractive index profile, remains unchanged or the same in the longitudinal direction of the fiber from the enlarged fiber end to the longitudinal section (at least as far as into the longitudinal section of the optical fiber). This means the refractive index profile has a continues extent in the longitudinal direction, i.e., the refractive index profile extends along the longitudinal direction without abrupt changes regarding the refractive index.

Because there are no abrupt changes of the refractive index profile in the longitudinal direction, there is no interference is created at the transition from the larger diameter to the smaller diameter and vice versa due to increased light absorption.

The light of a powerful laser, for example, can be coupled in and out at this optical surface. Because no splices (splice surfaces) or the like are present in this type of diameter enlargement, no overheating or destruction occurs.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for generating a diameter-enlarged end on an optical fiber, comprising:
placing a longitudinal subsection of a longitudinal section of the fiber into a heating zone and heating the longitudinal subsection, wherein first and second sides of the longitudinal section on either side of the longitudinal subsection are situated outside the heating zone;
compressing the heated longitudinal subsection in a longitudinal direction of the optical fiber;
pushing the first side of longitudinal section toward the heating zone in the longitudinal direction and pulling the second side of the longitudinal section away from the heating zone in the longitudinal direction, wherein the first side of the longitudinal section is pushed to a greater degree than the second side of the longitudinal section is pulled, and
generating an optical entry surface of the fiber by cutting the enlarged longitudinal subsection transversely to the longitudinal direction of the fiber.

2. The method of claim 1, further comprising grinding and polishing the optical entry surface.

3. The method of claim 1, further comprising coating the entry surface to preserve optical properties of the entry surface.

4. The method of claim 1, wherein the first and second sides of the longitudinal section are moved at different speeds in a same direction and the longitudinal subsection is pushed through the heating zone with a speed corresponding a difference between the different speeds.

5. A device for generating a diameter-enlarged end on an optical fiber, comprising:
an actuator operatively connected to two holders and configured to move the two holders independent of each other in a same direction at different speeds, said holders being spaced apart from each other for holding a first and a second side of a longitudinal section of the optical fiber in a respective one of the holders;
a heating zone positioned between the two holders so that a longitudinal subsection of the optical fiber situated between the first and second sides of the longitudinal section is located in the heating zone when the fiber is held by the two holders, said heating device being configured to heat the longitudinal subsection above a softening point of a material of which the optical fiber is made,
said actuator being configured to displace one of the two holders so as to push the first side of the longitudinal section toward the heating zone in longitudinal direction of the optical fiber and to displace the other one of the two holders so as to pull the second side of the longitudinal section away from the heating zone in longitudinal direction to a greater degree by which the first side of the longitudinal section is pushed by the one of the two holders.

6. The device of claim 5, wherein the heating zone is formed by plasma.

7. The device of claim 6, wherein the heating device comprises opposing electrodes which generate the plasma and are electrically connected to each other via the plasma, said plasma being maintained and heated up by an electric current.

8. The device of claim 5, wherein the two holders move the first and second sides of the longitudinal section at different speeds in the same direction so that the longitudinal subsection is pushed through the heating zone with a speed corresponding to a difference between the different speeds, whereby the movement into the heating zone is always faster than the movement out of the heating zone.
